(19) United States
(12) Patent Application Publication
(10) Pub. No.: US 2026/0178963 A1
(43) Pub. Date: Jun. 25, 2026

(54) MACHINE LEARNING TECHNIQUES FOR DETECTION OF EXTORTION IN ELECTRONIC COMMUNICATIONS

(71) Applicant: eBay Inc., San Jose, CA (US)

(72) Inventors: Shiwam Mittal, Santa Clara, CA (US); Rahul Ajaykumar Agarwal, Santa Clara, CA (US); Hongye Li, Milpitas, CA (US)

(21) Appl. No.: 18/987,503

(22) Filed: Dec. 19, 2024

(51) Int. Cl. G06N 20/00

(52) U.S. Cl. CPC G06N 20/00

(57) ABSTRACT

A message from a first device of a first user for sending to a second device of a second user is received. Context for the message is generated based on a chat history between the first user and the second user. The chat history comprises one or more messages exchanged between the first user and the second user prior to receiving the message. The message is classified as attempted extortion by a machine learning model trained to classify the intention of messages based on content of the message and the context for the message. Based on classifying the message as attempted extortion, the message is prevented from being sent to the second device of the second user.

### TECHNICAL FIELD

The present disclosure generally relates to data processing using machine learning (ML) technologies. More particularly, various embodiments described herein provide for systems, methods, techniques, instruction sequences, and devices for ML-based detection of extortion in electronic communications.

### BACKGROUND

In the context of online platforms such as messaging and review platforms, feedback extortion occurs when a first user such as a buyer of goods or services exploits the threat of negative reviews to coerce a second user such as a seller of the goods or services into offering refunds, discounts, or other benefits to the first user that they are not entitled to. Similarly, complaint extortion occurs when a user threatens to file complaints against another user unless they are given refunds, discounts or other benefits to which they are also not entitled to. These unethical practices compromise the fairness of the communication platform, damaging the trust between users. Users who are subject to extortion attempts are often forced into making concessions to avoid negative feedback or complaints, even when they have fulfilled their obligations. Current online platforms lack effective technologies to detect and prevent this behavior, leaving users vulnerable to manipulation.

### BRIEF DESCRIPTION OF THE DRAWINGS

The present disclosure will be understood more fully from the detailed description given below and from the accompanying drawings of various embodiments of the disclosure. Some embodiments are illustrated by way of examples, and not limitations, in the accompanying figures.

FIG. 1 is a block diagram showing an example network environment that includes a messaging system, according to various examples of the present disclosure.

FIG. 2 is a block diagram illustrating components of an example messaging system, according to various examples of the present disclosure.

FIG. 3 is a data flow diagram illustrating a flow of operations in an example ML-based process for detecting and handling attempted extortion in messages exchanged between users of the messaging system, according to various examples of the present disclosure.

FIG. 4 and FIG. 5 are flowcharts illustrating an example method for detecting and handling attempted extortion in messages exchanged between users of the messaging system, according to various examples of the present disclosure.

FIG. 6 is an interface diagram illustrating example views of a user interface of the messaging system to facilitate an exchange of messages between users, according to various examples of the present disclosure.

FIG. 7 is a block diagram illustrating an ML pipeline, according to some example embodiments.

FIG. 8 is a data flow diagram illustrating training and use of an ML program, according to some example embodiments.

FIG. 9 is a block diagram illustrating a representative software architecture, which may be used in conjunction with various hardware architectures herein described, according to various examples of the present disclosure.

FIG. 10 is a block diagram illustrating components of a machine able to read instructions from a machine storage medium and perform any one or more of the methodologies discussed herein according to various examples of the present disclosure.

### DETAILED DESCRIPTION

The description that follows includes systems, methods, techniques, instruction sequences, and computing machine program products that embody illustrative embodiments of the present disclosure. In the following description, for purposes of explanation, numerous specific details are set forth in order to provide a thorough understanding of embodiments. It will be evident, however, to one skilled in the art that the present inventive subject matter may be practiced without these specific details. Furthermore, well-known features may be omitted or simplified in order not to obscure the described embodiments.

As addressed above, feedback extortion in online platforms refers to the practice of manipulating or threatening to manipulate reviews in order to gain an unfair advantage or extract concessions from businesses or service providers while complaint extortion refers to the practice of threatening to file complaints in order to gain similar advantages and concessions. As an example, a user may threaten to leave negative reviews or file complaints unless they receive additional benefits, discounts, or preferential treatment beyond what was initially agreed upon or advertised. This practice undermines the integrity of online platforms, especially review platforms, which are designed to provide honest and unbiased feedback about products, services, or experiences. Feedback and complaint extortion can significantly impact a seller's or business's reputation and financial performance, as many consumers rely on online reviews to make purchasing decisions. Online platforms (e.g., online marketplaces) often prohibit feedback and complaint extortion and may implement measures such as double-blind review processes to mitigate this issue. However, these measures are often ineffective in detecting, much less preventing, extortion and conventional online platforms otherwise lack technologies to accurately detect and handle extortion attempts.

Aspects of the present disclosure address the technical deficiencies of traditional online platform handling of feedback and complaint extortion (referred to hereinafter collectively as “extortion”) with systems, methods, techniques, instruction sequences, and computing machine program products that utilize a trained machine learning (ML) model such as a large-language model (LLM) to detect extortion attempts in messages exchanged between users of a messaging system of an online platform. In addition, a verification agent verifies whether messages classified as attempted extortion are properly classified and input from the agent can be used to retrain the ML model.

In an example, a messaging system facilitates electronic chat conversations (also referred to herein simply as “electronic conversations”) by allowing users to exchange messages that can include text, audio, images, and/or videos. The messaging system may be part of an online platform that further includes a review system that allows users to review goods and services as well as the entities (e.g., businesses and individual sellers) that engage in transactions for the goods and services. The online platform may further include a publication system that allows users (e.g., sellers) to publish listings to offer the goods and services for sale. The messaging system receives a message from a first user to send to a second user as part of an electronic conversation between the users. The conversation may, for example, pertain to one or more goods or services offered for sale or purchased via a listing published by the publication system. That is, the first user may be a buyer of a good or service and the second user may be the seller of the good or service. The messaging system generates context for the message based on a chat history between the users and based on the context, the messaging system classifies the message as attempted extortion using an ML model trained to classify an intent of messages. For example, the message may include a threat from the first user to provide a negative review on the review system for the good or service if the second user does not provide a discount or refund for which the first user is not entitled. Based on the message being classified as attempted extortion, the messaging system blocks the message from being sent to the second user and prevents the users from exchanging further messages.

A verification agent verifies whether the message is properly classified as attempted extortion based on communications with the first and second user. If the verification agent determines that the message was not properly classified as attempted extortion, the ML model is retrained based on input from the verification agent and the messaging system sends the message to the second user and allows the users to continue messaging. On the other hand, if the verification agent determines that the message is properly classified as attempted extortion, further messaging between the users continues to be blocked.

By utilizing an ML model trained to classify the intent of messages, the ability of the messaging system to detect and prevent attempted extortion is improved relative to traditional online messaging systems that completely lack this capability, thereby also improving the functionality and integrity of online review systems by eliminating incentives for disingenuous reviews. Furthermore, the accuracy of the ML model in classifying messages as attempted extortion is improved through retraining when the ML model improperly classifies a message as attempted extortion, as determined by the verification agent. In addition, utilization of the verification agent further improves the functioning of online messaging systems by providing a mechanism for users to continue messaging after a false positive classification of attempted extortion whereas with traditional messaging systems users may be prohibited from further messages despite there being no actual attempts at extortion in their communications.

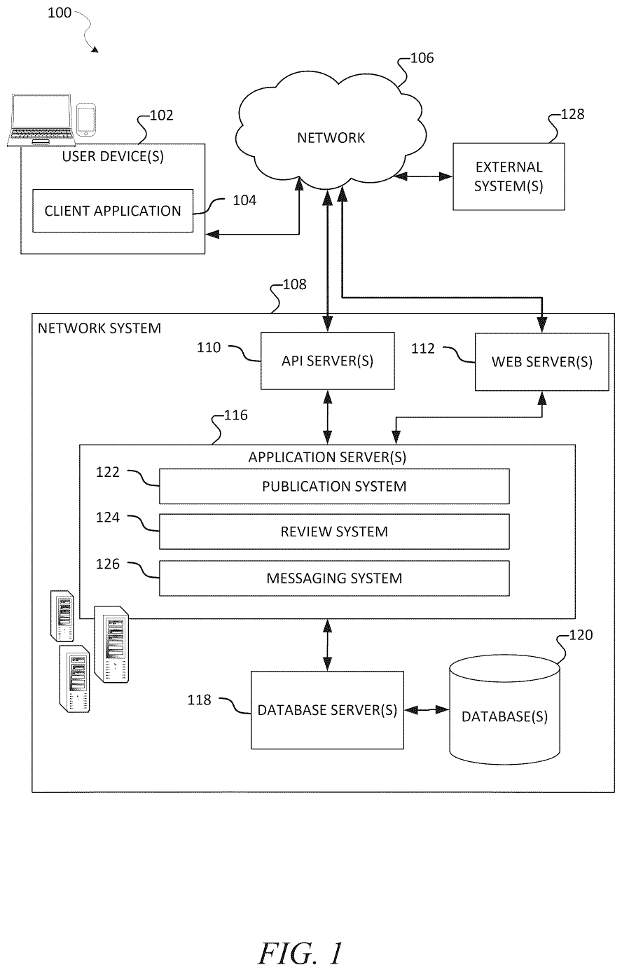

FIG. 1 is a block diagram showing an example network environment 100 that includes a messaging system 126, according to various examples of the present disclosure. As shown, the network environment 100 includes one or more user devices 102, a network system 108, and a network 106 (e.g., Internet, wide-area-network (WAN), local-area-network (LAN), wireless network) that communicatively couples them together. Each user device 102 can host a number of applications, including a client software application 104. The client software application 104 can communicate and exchange data with the network system 108 via a network 106.

A user device 102 may comprise but is not limited to, a smartphone, tablet, laptop, multi-processor systems, microprocessor-based or programmable consumer electronics, game consoles, or any other communication device that can access the network system 108. Additionally, each user device 102 comprises a display component (not shown) to display information (e.g., in the form of user interfaces) as will be discussed in more detail below.

The network system 108 provides server-side functionality via the network 106 to the client software application 104. While certain functionality is described herein as being performed by the messaging system 126 on the server system 108, it will be appreciated that the location of certain functionality within the network system 108 is a design choice. For example, it may be technically preferable to initially deploy certain technology and functionality within the network system 108, but to later migrate this technology and functionality to the client software application 104.

The network system 108 supports various services and operations that are provided to the client software application 104 by a publication system 122, a review system 124, and the messaging system 126. Further details regarding the various services and operations provided by publication system 122, a review system 124, and the messaging system 126 are discussed below, but generally, these operations include: transmitting data from any one or more of the publication system 122, the review system 124, and the messaging system 126 to the client software application 104; receiving data from the client software application 104 at any one or more of the publication system 122, the review system 124, and the messaging system 126; and processing data generated by the client software application 104. Data exchanges within the network environment 100 may be invoked and controlled through operations of software component environments available via one or more endpoints, or functions available via one or more user interfaces of the client software application 104, which may include web-based user interfaces provided by the server system 108 for presentation at the user device 102.

With respect to the network system 108, one or more application programing interface (API) servers 110 and one or more web servers 112 are coupled to and provide programmatic and web interfaces respectively to one or more application servers 116. The application server(s) 116 host various systems including the publication system 122, the review system 124, and the messaging system 126, each of which comprises a plurality of components and each of which can be embodied as hardware, software, firmware, or any combination thereof. The application server(s) 116 are, in turn, coupled to one or more database servers 118 that facilitate access to one or more databases 120. The database(s) 120 may be stored in one or more storage devices and may, for example, include user accounts including user profiles of users of the network system 108 and can also store chat histories between users utilizing functionality of the messaging system 126.

The API server(s) 110 receives and transmits data (e.g., API calls, commands, requests, responses, and authentication data) between the user device(s) 102 and the application server 116. Specifically, the API server(s) 110 provides a set of interfaces (e.g., routines and protocols) that can be called or queried by the client software application 104 in order to invoke the functionality of the application server(s) 116. The API server(s) 110 expose various functions supported by the application server 116 including, without limitation, messaging, listing publication, and review of goods and services and sellers thereof.

The publication system 122 manages publications (e.g., articles, listings of available goods or services) and transactions (e.g., for goods and services) at the network system 108 including generating and publishing the publications, conducting searches for publications, and/or maintaining user accounts.

The review system 124 allows users to provide feedback on goods and services as well as the sellers of goods and services. Utilizing the review system 124, users can rate goods, services, and sellers thereof on various aspects such as quality, shipping speed, and customer service, providing a comprehensive evaluation. The review system 124 may aggregate and analyze review data to present summary statistics and trends to users.

The messaging system 126 facilitates electronic chat conversations between users by allowing them to exchange messages that include text, audio, images, and/or videos. The messaging system 126 utilizes an ML model to analyze and classify messages. In some examples, the ML model may classify a message as attempted extortion, and in response to the message being classified as attempted extortion, the messaging system 126 prevents the message from being sent and prevents further messaging in the electronic conversation in which the message is to be sent. The messaging system 126 further employs verification agents to verify whether messages are properly classified as attempted extortion, and if the verification agent determines that a message is not properly classified, the message is sent, further messaging is allowed, and the ML model is retrained. Further details regarding the messaging system 126 are discussed below.

The environment 100 can also comprise one or more external systems 128. The external system(s) 128 can be a third-party system that performs data operations or processing for the network system 108. For example, the external system(s) 128 can comprise a large language model (LLM) or generative artificial intelligence (AI) system that processes data on behalf of the network system 108. The LLM is a trained model configured to generate text and perform natural language processing tasks such as classifying an intent of messages.

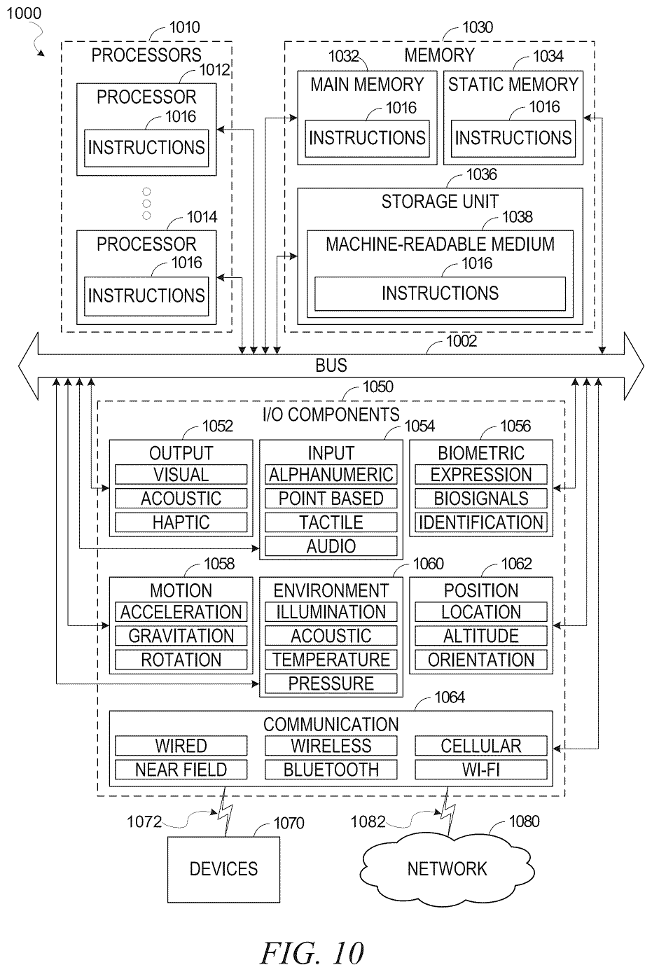

Any of the systems, data storage, or devices (collectively referred to as “components”) shown in, or associated with, FIG. 1 may be, include, or otherwise be implemented in a special-purpose (e.g., specialized or otherwise non-generic) computer that can be modified (e.g., configured or programmed by software, such as one or more software components of an application, operating system, firmware, middleware, or other program) to perform one or more of the functions described herein for that system or machine. For example, a special-purpose computer system able to implement any one or more of the methodologies described herein is discussed below with respect to FIG. 10, and such a special-purpose computer is a means for performing any one or more of the methodologies discussed herein. Within the technical field of such special-purpose computers, a special-purpose computer that has been modified by the structures discussed herein to perform the functions discussed herein is technically improved compared to other special-purpose computers that lack the structures discussed herein or are otherwise unable to perform the functions discussed herein. Accordingly, a special-purpose machine configured according to the systems and methods discussed herein provides an improvement to the technology of similar special-purpose machines.

Moreover, any two or more of the components illustrated in FIG. 1 may be combined, and the functions described herein for any single component may be subdivided among multiple components. Functionalities of one system may, in alternative examples, be embodied in a different system. For example, any of the functionalities discusses above with respect to the messaging system 126 may be embodied within the user device 102, the publication system 122, or the review system 124. While only a single network system 108 is shown, alternatively, more than one network system 108 can be included (e.g., localized to a particular region).

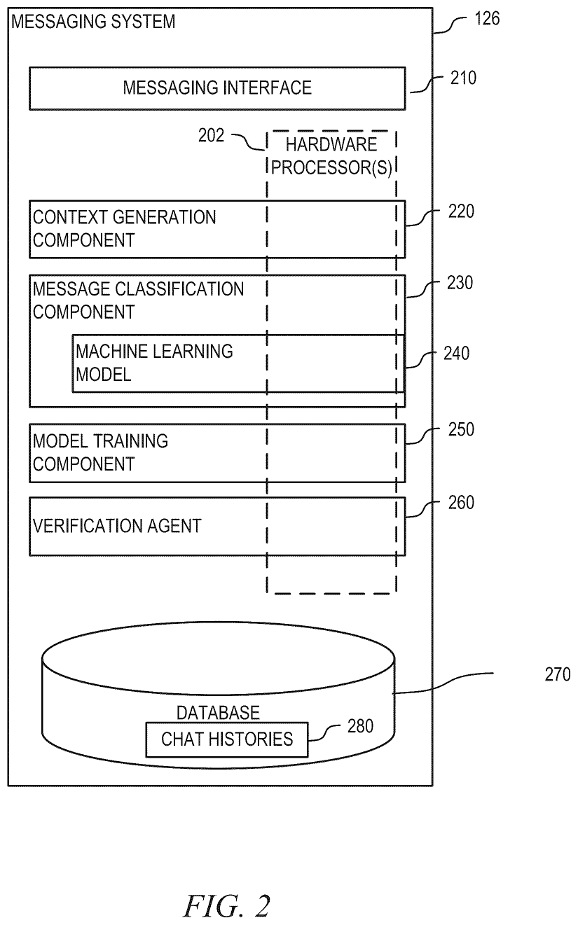

FIG. 2 is a block diagram illustrating components of the messaging system 126, according to various examples of the present disclosure. As shown, the messaging system 126 comprises a messaging interface 210, a context generation component 220, a message classification component 230, an ML model 240, a model training component 250, a verification agent 260, and a database 270. According to various examples, any one or more of the context generation component 220, the message classification component 230, the ML model 240, the model training component 250, and the verification agent 260 can be implemented by one or more hardware processors 202.

The messaging interface 210 facilitates communications between users by allowing users to exchange messages in the context of one or more electronic conversations. Messages exchanged between users can include any one or more of text, audio, an image, or a video. The messaging interface 210 can be displayed by any one of the user devices 102 based, for example, on machine-readable instructions provided by the messaging system 126 to a client application 104.

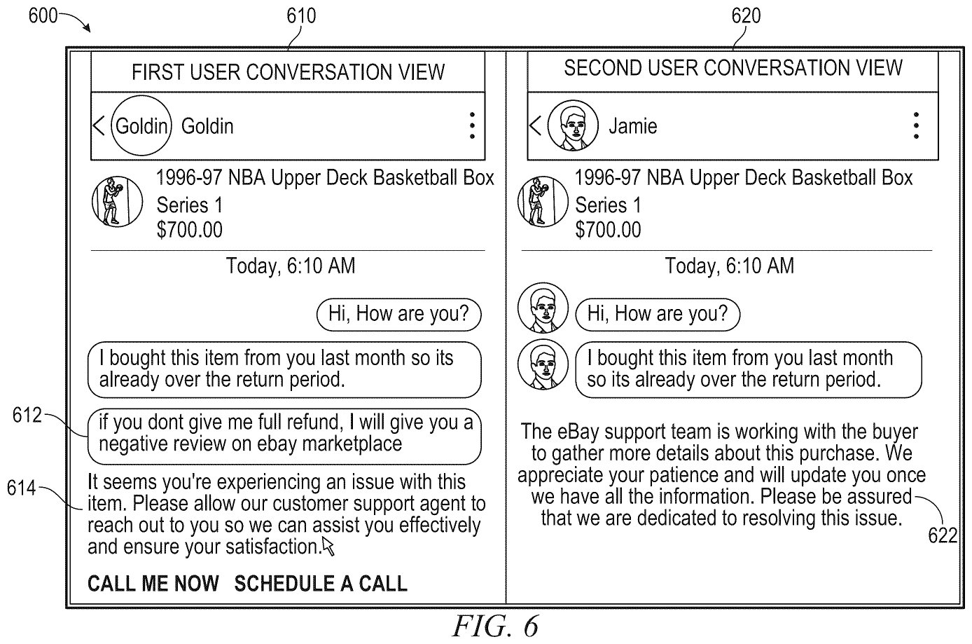

The messaging interface 210 may include multiple views such as a conversation view. As used herein, a “view” is a component of a user interface that includes an output representation of information in a particular format. Each of the multiple views may provide or enable different functionality with respect to the messaging system 126. As noted above, the messaging interface 210 includes a conversation view that allows users to author, send, and view messages exchanged as part of an electronic conversation between users. The conversation view includes graphical representations of each participating user (e.g., an image of the user) and one or more messages exchanged between participating users. Example conversation views of the messaging interface 210 are illustrated in FIG. 6 and described below.

The context generation component 220 is responsible for generating context for messages for subsequent analysis and classification. As an example, to generate context for a given message exchanged between two users in an electronic conversation, the context generation component 220 accesses one or more chat histories 280 from the database 270 and extracts one or more previously exchanged messages between the two users that can be used to fully understand and assess the message. The context generation component 220 can extract messages from the current conversation between the two users and/or one or more previous conversations.

In addition to chat histories 280, in some examples, the context generation component 220 can generate context for messages based on any one or more of user profile data, user transaction history, user feedback history, and user publication history, any one of which can be stored in and accessed from the database 270.

The message classification component 230 is responsible for classifying an intent of messages exchanged between users of the messaging system 126. The message classification component 230 utilizes an ML model 240 (e.g., a large language model (LLM)) to analyze the content and context for the message provided by the context generation component 220 for each received message and classify its intent into one or more predefined classifications. For example, utilizing the ML model 240, the message classification component 230 can classify a message as attempted extortion. As shown in the example of FIG. 2, the ML model 240 forms part of the message classification component 230, though in other examples, the ML model 240 may be an independent component of the messaging system 126. In some examples, the message classification component 230 may encode the content of the message (e.g., text, audio, or video) and its context into a format suitable for processing by the ML model 240 prior to processing by the ML model 240.

In instances in which the message classification component 230 classifies a message as attempted extortion, the messaging system 126 blocks the message from being sent to the intended recipient user and blocks further messages from being exchanged in the conversation, pending further processing by the verification agent 260. That is, the messaging system 126 prevents the message from being displayed in a conversation view of the messaging interface 210 of the recipient user and prohibits both the recipient user and the sending user from using the conversation view to author further messages in the conversation, at least until the verification agent 260 verifies the message is properly classified as attempted extortion.

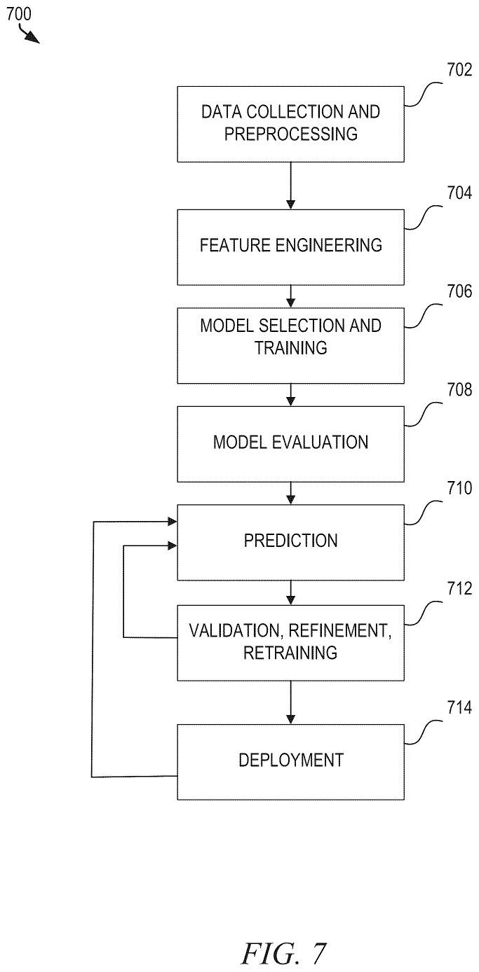

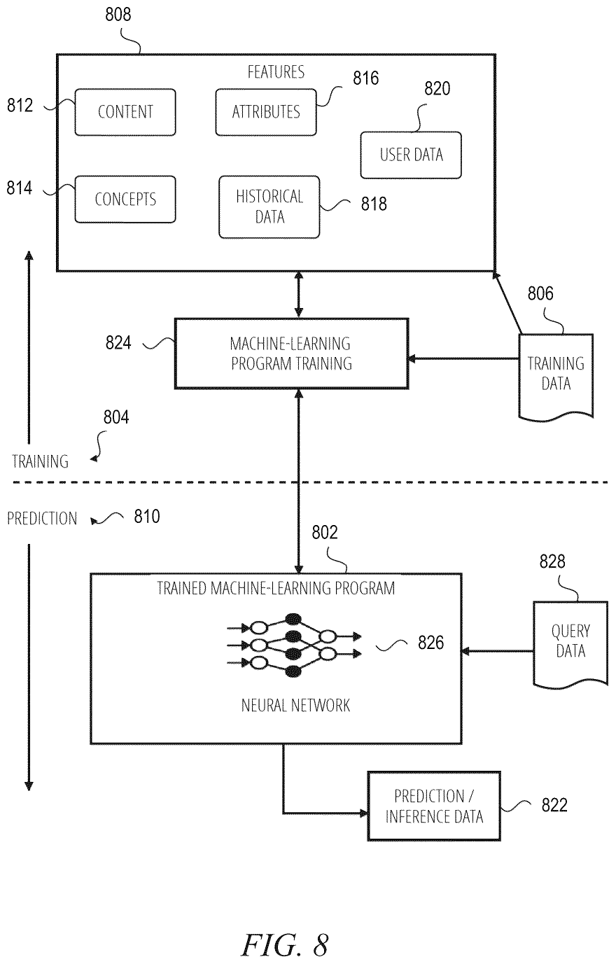

The model training component 250 is configured to train and retrain the ML model 240. In some examples, the model training component 250 trains the ML model 240 on a corpus of labeled message data (e.g., labeled according to the corresponding intent of messages). In some examples, the model training component 250 retrains the ML model 240 based on input from the verification agent 260. Further details regarding an ML pipeline and training and use of an example ML model are discussed below in reference to FIG. 7 and FIG. 8.

The verification agent 260 is responsible for verifying the classification of messages. For example, a verification agent 260 can verify whether a message was properly classified as attempted extortion. In the example illustrated by FIG. 2, the verification agent 260 is a machine-implemented agent, though in other examples, the verification agent 260 is a human agent. Consistent with the example illustrated by FIG. 2, the verification agent 260 comprises a machine-implemented agent, such as a chatbot, that includes an artificial intelligence (AI) powered software system configured to interact with users through natural language processing and generation.

In an example, the verification agent 260 verifies a message is properly classified as attempted extortion by communicating with the sending user and communicating with the recipient user. The verification agent 260 determines based on the communications with the two users whether the message is properly classified as attempted extortion. If the verification agent 260 determines a message is improperly classified as attempted extortion, the messaging system 126 allows the message to be sent to the recipient user and once again allows the users to exchange message. Otherwise, the messaging system 126 continues to block the message from being sent and continues to prevent messages being exchanged between the two users.

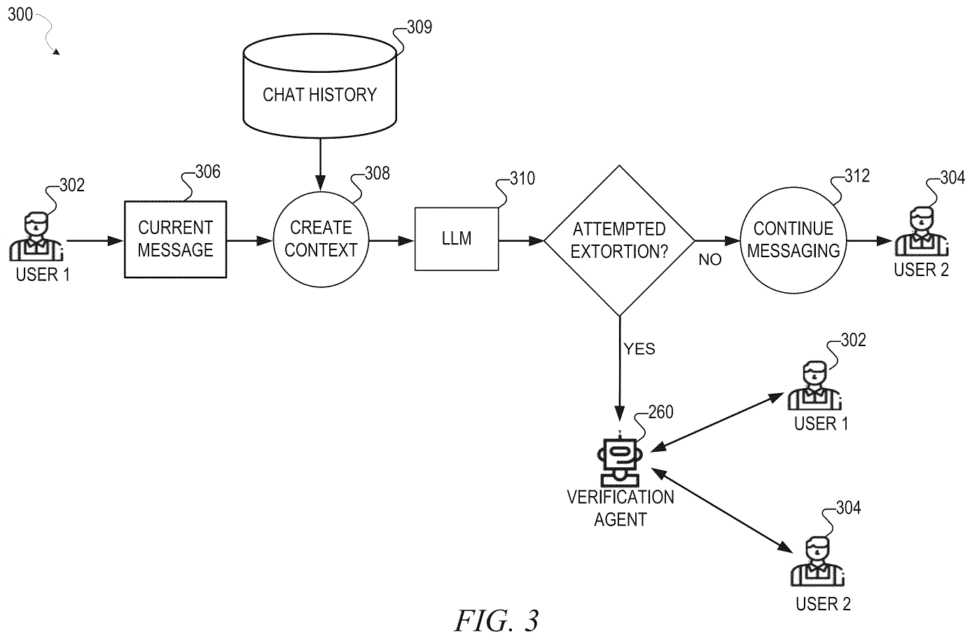

FIG. 3 is a data flow diagram illustrating a flow of operations in an example ML-based process 300 for detecting and handling attempted extortion in messages exchanged between users of the messaging system, according to various examples of the present disclosure. In the context of FIG. 3, a first user 302 (also referenced in FIG. 3 as “USER 1”) using a first user device and a second user 304 (also referenced in FIG. 3 as “USER 2”) using a second user device are engaged in an electronic conversation in which messages are being exchanged between the users (e.g., messages are sent to and from respective user devices).

As shown, a message 306 from the first user 302 for sending to the second user 304 is received by the messaging system 126 (e.g., received from a first user device). The context generation component 220 creates context for the message 306, at operation 308, based at least in part on a chat history 309 between the first user 302 and the second user 304. The chat history 309 includes at least one or more previous messages exchanged between the first user 302 and the second user 304 as part of the current conversation and may further include one or more previous messages from one or more previous conversations. In some examples, the context generation component 220 creates the context for the message based on any one or more of: a user profile of the first or second user; a transaction history of the first or second user; and a feedback history of the first or second user (previous reviews submitted by the first or second user and/or reviews of the first or second user).

Utilizing the ML model 240, in the example form of an LLM 310, the message classification component 230 classifies an intent of the message 306 based on the content of the message and the context for the message generated by the context generation component 220. If the message classification component 230 classifies the intent of the message 306 as something other than attempted extortion, the messaging system 126 allows the users to continue messaging, at operation 312, and the message is sent to the second user 304 (e.g., sent to a second user device of the second user 304). On the other hand, if the message 306 as attempted extortion, the message 306 is not sent to the second user 304 and the message 306 is instead provided to the verification agent 260 to verify that the message 306 is properly classified as attempted extortion. Though the message is not sent to the second user 304, in some examples, the message 306 is displayed in a conversation view (e.g., of the messaging interface 210) of the first user 302 and stored in the chat history (e.g., one of the chat histories 280 stored in the database 270) of the first user 302.

To verify the classification of the message 306, the verification agent 260 communicates with the first user 302 and further communicates with the second user 304 to determine additional information that can be used to determine whether the message 306 is attempted extortion. In communication with the users, the verification agent 260 exchanges one or more messages with the users. In some instances, the verification agent 260 may follow up with additional communications with one or more of the two users based on communications with the other user. If the verification agent 260 determines that the message 306 has been improperly classified as attempted extortion, the message 306 is sent to the second user 304, the users are allowed to continue messaging, and the LLM 310 is retrained. If the verification agent 260 verifies the message 306 was properly classified, the message 306 is never sent to the second user 304 and the users are not allowed to continue messaging. In some examples, further action may be taken with respect to the first user 302 such as blocking the first user 302 from using the messaging system 126 or providing reduced functionality to the first user 302.

The process 300 described above may be repeated for each new message received as part of the conversation between the user 302 and the user 304. That is, a first message may be received, classified as something other than attempted extortion, and messages classified as something other than attempted extortion may continue to be exchanged between the users until a second message is received that is classified as attempted extortion.

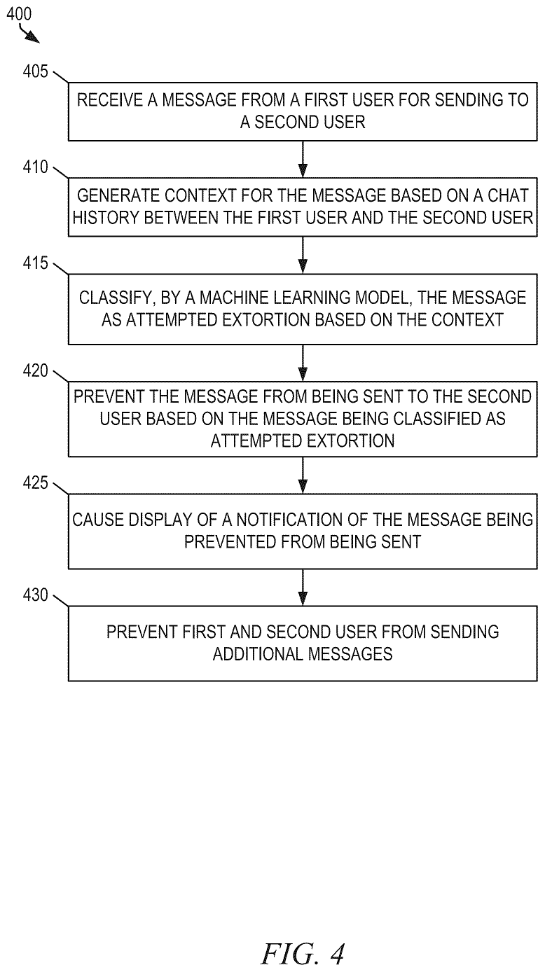

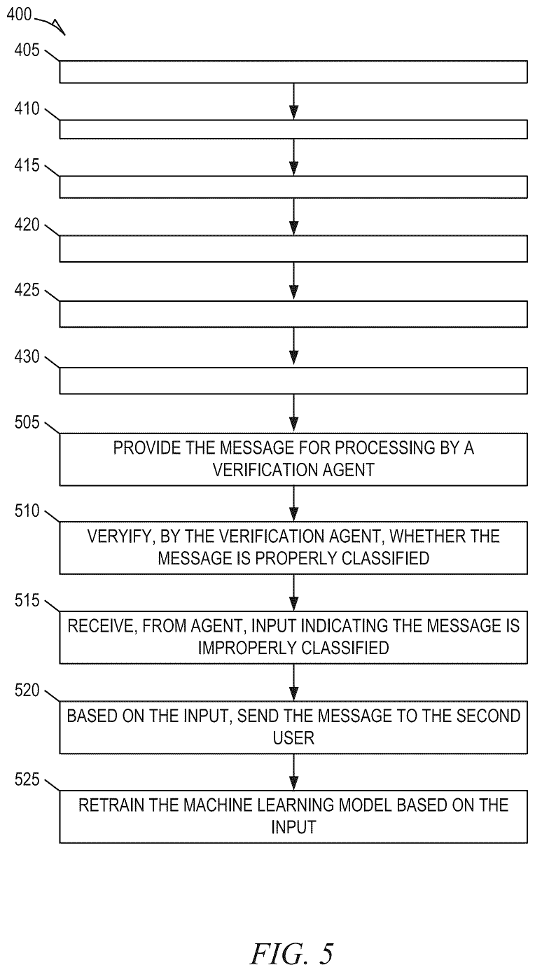

FIG. 4 and FIG. 5 are flowcharts illustrating an example method 400 for detecting and handling attempted extortion in messages exchanged between users of the messaging system, according to various examples of the present disclosure. It will be understood that example methods described herein may be performed by a machine in accordance with some examples. For example, method 400 can be performed by the messaging system 126 described with respect to FIG. 1 and FIG. 2, or individual components thereof. An operation of various methods described herein may be performed by one or more hardware processors (e.g., central processing units or graphics processing units) of a computing device (e.g., a desktop, server, laptop, mobile phone, tablet, etc.), which may be part of a computing system based on a cloud architecture. Example methods described herein may also be implemented in the form of executable instructions stored on a machine-readable medium or in the form of electronic circuitry. For instance, the operations of method 400 may be represented by executable instructions that, when executed by a processor of a computing device, cause the computing device to perform method 400. Accordingly, the operations of the method 400 are described below in reference to such a computing device.

Depending on the embodiment, an operation of an example method described herein may be repeated in different ways or involve intervening operations not shown. Though the operations of example methods may be depicted and described in a certain order, the order in which the operations are performed may vary among examples, including performing certain operations in parallel.

At operation 405, a computing device receives a message from a first user device (e.g., one of the user devices 102) of a first user for sending to a second device (e.g., another one of the user devices 102) of a second user. In an example, the message can comprise any one or more of text, audio, an image, or a video. The message may be one of multiple messages exchanged between the first user and the second user in the context of a conversation facilitated by a messaging system (e.g., the messaging system 126). To facilitate the conversation between the first and second user, the messaging system provides a messaging interface to the first and second device. The messaging interface includes a conversation view that displays messages exchanged between the first user and the second user. Example conversation views of a first user and second user from the messaging interface are illustrated in FIG. 6 and discussed below.

At operation 410, the computing device generates context for the message based at least in part on a chat history between the first user and the second user. The chat history comprises one or more messages previously exchanged between the first user and the second user at least in the conversation in which the message received at operation 405 was sent. The chat history may include one or more messages from previous conversations between the first user and the second user. The computing device accesses the chat history from a database of chat histories (e.g., from chat histories 280 stored in the database 270). In generating the context, the computing device parses the chat history and extracts one or more messages from the chat history that provide additional information that can be used to fully understand and assess the message received at operation 405.

Consistent with some examples, the computing device generates context for a message based on any one or more of: a user profile of the first or second user; a transaction history of the first or second user; and a feedback history of the first or second user (previous reviews submitted by the first or second user or reviews of the first or second user).

At operation 415, the computing device uses an ML model (e.g., ML model 240) to classify the intention of the message based on the message content and the context. More specifically, the ML model classifies the message as attempted extortion based on the context. The ML model is trained (e.g., by the model training component 250) to classify the intention of messages. Further details regarding ML model training are discussed below in reference to FIG. 7 and FIG. 8.

At operation 420, the computing device prevents the message from being sent to the second device of the second user based on the message being classified as attempted extortion. In some examples, though the message is not sent to the second device of the second user, the message may be displayed in the conversation view of the first user presented by the messaging interface of the first device. Consistent with these examples, the message is stored in a chat history (e.g., one of the chat histories 280 stored in the database 270) of the first user so that the chat history of the first user is up to date.

At operation 425, the computing device causing display of a notification of the message being prevented from being sent by one or more of the first user device and the second user device. The notification may be displayed as part of a conversation view of the messaging interface provided to the first and second user device. An example of such a notification is illustrated in FIG. 6 and described below.

At operation 430, the computing device prevents the first and second user from sending additional messages based on the message being classified as attempted extortion.

As shown in FIG. 5, the method 400 can, in some examples, include operations 505, 510, 515, 520, and 525. Consistent with some examples, operations 505, 510, 515, 520, and 525 are performed subsequent to the operation 430 where the computing device prevents the first and second users from sending additional messages based on the message being classified as attempted extortion.

At operation 505, the computing device provides the message for processing by a verification agent. The verification agent may be a human agent or a machine-implemented agent.

At operation 510, the verification agent verifies whether the message is properly classified as attempted extortion. In the example addressed by FIG. 5, the verification agent determines that the message is improperly classified as attempted extortion. In other examples, the verification agent verifies that the message is properly classified and no further action is taken by the computing device. That is, the computing device continues to prevent the message from being sent to the second user and prevents the first user and the second user from exchanging any further messages.

In an example, the verification agent verifies whether the message is properly classified as attempted extortion by communicating with the first user regarding the message and communicating with the second user regarding the message to determine whether extortion is being attempted by the first user.

At operation 515, the computing device receives input from the verification agent indicating that the message is improperly classified. Based on the input received from the verification agent, the computing system sends the message to the second user and allows the first user and second user to continue to exchange messages, at operation 520. The computing device further retrains the ML model, at operation 525, based on the input to improve the ML model's ability to properly classify an intention of messages.

FIG. 6 is an interface diagram illustrating example views of a user interface 600 of the messaging system to facilitate an exchange of messages between users, according to various examples of the present disclosure. More specifically, FIG. 6 illustrates a first user conversation view 610 and a second user conversation view 620. Both the first user conversation view 610 and the second user conversation view 620 display messages exchanged between a first user and a second user in the context of an electronic conversation. In the example illustrated by FIG. 6, the first user is a buyer in a transaction for an item (specifically “1996-97 NBA Upper Deck Basketball Box Series 1”), the second user is the seller of the item, and the messages exchanged as part of the conversation pertain to the transaction.

As shown in the first user conversation view 610, the first user has attempted to send message 612 to the second user. However, the message 612 has been classified (e.g., by the message classification component 230) as attempted extortion. Accordingly, the messaging system 126 has prevented the message from being sent to the second user and thus the message 612 is not included in the conversation view 620, though it is displayed by the first user conversation view 610. In addition, the conversation view 610 includes a notification 614 that indicates that the message 612 is not being sent to the second user and allows the user to contact a verification agent to aid in the agent's verification of the classification of the message as attempted extortion. Similarly, the second user conversation view 620 includes notification 622 that indicates an issue with the communication between the first user and the second user.

Described implementations of the subject matter can include one or more features, alone or in combination, as illustrated below by way of example.

Example 1. A system comprising: one or more processors; and a memory storing instructions that, when executed by the one or more processors, cause the one or more processors to perform operations comprising: receiving, by at least one hardware processor, a message from a first device of a first user for sending to a second device of a second user; generating context for the message based on a chat history between the first user and the second user, the chat history comprising one or more messages exchanged between the first user and the second user prior to receiving the message; classifying, by a machine learning model trained to classify an intention of messages, the message as attempted extortion based on content of the message and the context for the message; and based on classifying the message as attempted extortion, preventing, by the at least one hardware processor, the message from being sent to the second device of the second user.

Example 2. The system of Example 1, wherein the operations comprise: providing the message for processing by a verification agent in response to classifying the message as attempted extortion; and verifying, by the verification agent, whether the message is properly classified as attempted extortion.

Example 3. The system of any one or more of Examples 1 or 2, wherein the operations comprise: receiving, from the verification agent, input permitting the message to be sent to the second device of the second user; and based on the input, sending the message to the second device of the second user.

Example 4. The system of any one or more of Examples 1-3, wherein the verifying whether the message is properly classified as attempted extortion comprises: communicating, by the verification agent, with the first user regarding the message; and communicating, by the verification agent, with the second user regarding the message.

Example 5. The system of any one or more of Examples 1-4, comprising: receiving, from the verification agent, input indicating that the message is improperly classified as attempted extortion; and retraining the machine learning model using the input.

Example 6. The system of any one or more of Examples 1-5, wherein the generating of the context is further based on at least one of: a user profile of the first user, a user profile of the second user, a transaction history of the first user, a transaction history of the second user, a feedback history of the first user, and a feedback history of the second user.

Example 7. The system of any one or more of Examples 1-6, wherein the operations comprise causing display, at the second device of the second user, of a notification of the message being prevented from being sent to the second device.

Example 8. A method comprising: receiving, by at least one hardware processor, a message from a first device of a first user for sending to a second device of a second user; generating context for the message based on a chat history between the first user and the second user, the chat history comprising one or more messages exchanged between the first user and the second user prior to receiving the message; classifying, by a machine learning model trained to classify an intention of messages, the message as attempted extortion based on content of the message and the context for the message; and based on classifying the message as an attempted extortion, preventing, by at least one hardware processor, the message from being sent to the second device of the second user.

Example 9. The method of Example 8, comprising: providing the message for processing by a verification agent in response to classifying the message as attempted extortion; and verifying, by the verification agent, whether the message is properly classified as attempted extortion.

Example 10. The method of any one or more of Examples 8 or 9, comprising: receiving, from the verification agent, input permitting the message to be sent to the second device of the second user; and based on the input, sending the message to the second device of the second user.

Example 11. The method of any one or more of Examples 8-10, wherein the verifying whether the message is properly classified as attempted extortion comprises: communicating, by the verification agent, with the first user regarding the message; and communicating, by the verification agent, with the second user regarding the message.

Example 12. The method of any one or more of Examples 8-11, comprising: receiving, from the verification agent, input indicating that the message is improperly classified as attempted extortion; and retraining the machine learning model using the input.

Example 13. The method of any one or more of Examples 8-12, wherein the generating of the context is further based on at least one of: a user profile of the first user, a user profile of the second user, a transaction history of the first user, a transaction history of the second user, a feedback history of the first user, and a feedback history of the second user.

Example 14. The method of any one or more of Examples 8-13, comprising causing display, at the second device of the second user, of a notification of the message being prevented from being sent to the second device.

Example 15. The method of any one or more of Examples 8-14, comprising causing display, by the second device, of an interactive interface comprising a conversation view, the conversation view comprising a chat history between the first and second user, wherein the notification is displayed within the conversation view.

Example 16. The method of any one or more of Examples 8-15, wherein the message comprises at least one of: text, audio, an image, or a video.

Example 17. The method of any one or more of Examples 8-16, comprising training the machine learning model using training data, the training data comprising a set of messages exchanged between users on a network-based platform, transaction outcomes associated with transactions on the network-based platform, and user feedback published by the network-based platform.

Example 18. The method of any one or more of Examples 8-17, wherein: the message is a first message; the method comprises: receiving a second message from the first device of the first user for sending to the second device of the second user; determining, by the machine learning model, a classification of the second message; determining, based on the classification, that the second message is not classified as attempted extortion; and based on determining the second message is not classified as attempted extortion, sending the second message to the second device of the second user.

Example 19. The method of any one or more of Examples 8-18, wherein the machine learning model comprises a large language learning model.

Example 20. A machine-storage medium comprising instructions which, when executed by one or more processors of a machine, cause the machine to perform operations comprising: receiving, by at least one hardware processor, a message from a first device of a first user for sending to a second device of a second user; generating context for the message based on a chat history between the first user and the second user, the chat history comprising one or more messages exchanged between the first user and the second user prior to receiving the message; classifying, by a machine learning model trained to classify an intention of messages, the message as attempted extortion based on content of the message and the context for the message; and based on classifying the message as attempted extortion, preventing, by the at least one hardware processor, the message from being sent to the second device of the second user.

FIG. 7 depicts an ML pipeline 700 and FIG. 8 illustrates training and use of an ML program 802 (e.g., ML model 240), in accordance with some examples. The ML pipeline 700 can be used to generate a trained model such as the trained ML program 802 or, in some examples, the ML model 240 to perform operations associated with schematic data capture.

ML may involve using computer algorithms to automatically learn patterns and relationships in data, potentially without the need for explicit programming. ML algorithms can be divided into four main categories: supervised learning, unsupervised learning, self-supervised learning, and reinforcement learning.

For example, supervised learning involves training a model using labeled data (e.g., labeled messages from chat histories 280) to predict an output for new, unseen inputs. Examples of supervised learning algorithms include linear regression, decision trees, and neural networks.

Unsupervised learning involves training a model on unlabeled data to find hidden patterns and relationships in the data. Examples of unsupervised learning algorithms include clustering, principal component analysis, and generative models like autoencoders.

Reinforcement learning involves training a model to make decisions in a dynamic environment by receiving feedback in the form of rewards or penalties. Examples of reinforcement learning algorithms include Q-learning and policy gradient methods.

Examples of specific ML algorithms that may be deployed, according to some examples, include logistic regression, which is a type of supervised learning algorithm used for binary classification tasks. Logistic regression models the probability of a binary response variable based on one or more predictor variables. Another example type of ML algorithm is Naïve Bayes, which is another supervised learning algorithm used for classification tasks. Naïve Bayes is based on Bayes'theorem and assumes that the predictor variables are independent of each other. Random Forest is another type of supervised learning algorithm used for classification, regression, and other tasks. Random Forest builds a collection of decision trees and combines their outputs to make predictions.

Further examples include neural networks, which consist of interconnected layers of nodes (or neurons) that process information and make predictions based on the input data.

Matrix factorization is another type of ML algorithm used for recommender systems and other tasks. Matrix factorization decomposes a matrix into two or more matrices to uncover hidden patterns or relationships in the data. Support Vector Machines (SVM) are a type of supervised learning algorithm used for classification, regression, and other tasks. SVM finds a hyperplane that separates the different classes in the data. Other types of ML algorithms include decision trees, k-nearest neighbors, clustering algorithms, and deep learning algorithms such as convolutional neural networks (CNN), recurrent neural networks (RNN), and transformer models. The choice of algorithm depends on the nature of the data, the complexity of the problem, and the performance requirements of the application.

The performance of ML models is typically evaluated on a separate test set of data that was not used during training to ensure that the model can generalize to new, unseen data. For example, the performance of the ML model 240 can be evaluated using a separate validation set to ensure it generalizes well to new, unseen messages and message patterns.

Although several specific examples of ML algorithms are discussed herein, the principles discussed herein can be applied to other ML algorithms as well. Deep learning algorithms such as convolutional neural networks, recurrent neural networks, and transformers, as well as more traditional ML algorithms like decision trees, random forests, and gradient boosting may be used in various ML applications.

Two example types of problems in ML are classification problems and regression problems. Classification problems, also referred to as categorization problems, aim at classifying items into one of several category values (e.g., is this object an apple or an orange?). Regression algorithms aim at quantifying some items (for example, by providing a value that is a real number).

Turning to the training phase 804 as described and depicted in connection with FIG. 8 and performed, at least in part, by the model training component 250, in some examples, generating a trained ML program 802 may include multiple phases that form part of the ML pipeline 700, including for example the following phases illustrated in FIG. 7: data collection and preprocessing 702, feature engineering 704, model selection and training 706, model evaluation 708, prediction 710, validation, refinement, or retraining 712, and deployment 714, or a combination thereof.

For example, data collection and preprocessing 702 can include a phase for acquiring and cleaning data to ensure that it is suitable for use in the ML model 240. This phase may also include removing duplicates, handling missing values, and converting data into a suitable format. Feature engineering 704 can include a phase for selecting and transforming training data (e.g., chat histories 280) to create features that are useful for predicting the target variable. Feature engineering may include (1) receiving features 808 (e.g., as structured or labeled data in supervised learning) and/or (2) identifying features 808 (e.g., unstructured, or unlabeled data for unsupervised learning) in training data. Model selection and training 706 can include a phase for selecting an appropriate ML algorithm and training it on the preprocessed data. This phase may further involve splitting the data into training and testing sets, using cross-validation to evaluate the model, and tuning hyperparameters to improve performance.

In additional examples, model evaluation 708 can include a phase for evaluating the performance of a trained model (e.g., the trained ML program 802 or the ML model 240) on a separate testing dataset. This phase can help determine if the model is overfitting or underfitting and determine whether the model is suitable for deployment. The prediction 710 phase includes using a trained model (e.g., trained ML program 802 or the ML model 240) to generate predictions on new, unseen data. Validation, refinement, or retraining 712 can include a phase for updating a model based on feedback generated from the prediction phase, such as new data, user feedback, or input from a verification agent 260. Deployment 714 can include a phase for integrating the trained model (e.g., the trained ML program 802 or the ML model 240) into a more extensive system or application, such as the messaging system 126 or another web service, a mobile app, or an IoT device. This phase can involve setting up APIs, building a user interface, and ensuring that the model is scalable and can handle large volumes of data.

FIG. 8 illustrates further details of two example phases, namely a training phase 804 (e.g., part of the model selection and training 706), which is an example of the model training performed by the model training component 250, and a prediction 810 phase (part of the prediction 710 phase). Prior to the training phase 804, feature engineering 704 is used to identify features 808. This may include identifying informative, discriminating, and independent features for effectively operating the trained ML program 802 in pattern recognition, classification, and regression. In some examples, the training data 806 (e.g., chat histories 280), includes labeled data, known for pre-identified features 808 and one or more outcomes. Each of the features 808 may be a variable or attribute, such as an individual measurable property of a process, article, system, or phenomenon represented by a data set (e.g., the training data 806). Features 808 may also be of different types, such as numeric features, strings, and graphs, and may include one or more of content 812, concepts 814, attributes 816, historical data 818, and/or user data 820, merely for example and not limitation.

In the training phase 804, the ML pipeline 700 uses the training data 806 to find correlations among the features 808 that affect a predicted outcome or prediction/inference data 822. By way of non-limiting example, the training data 806 can include a corpus of messages from multiple chat histories 280 between users of the messaging system 126.

With the training data 806 and the identified features 808, the trained ML program 802 is trained during the training phase 804 during ML program training 824. The ML program training 824 appraises values of the features 808 as they correlate to the training data 806. The result of the training is the trained ML program 802 (e.g., a trained or learned model such as ML model 240).

Further, the training phase 804 may involve ML, in which the training data 806 is structured (e.g., labeled during preprocessing operations). The trained ML program 802 implements a neural network 826 capable of performing, for example, classification and clustering operations. In other examples, the training phase 804 may involve deep learning, in which the training data 806 is unstructured, and the trained ML program 802 implements a deep neural network 826 that can perform both feature extraction and classification/clustering operations.

In some examples, a neural network 826 may be generated during the training phase 804 and implemented within the trained ML program 802. The neural network 826 includes a hierarchical (e.g., layered) organization of neurons, with each layer consisting of multiple neurons or nodes. Neurons in the input layer receive the input data, while neurons in the output layer produce the final output of the network. Between the input and output layers, there may be one or more hidden layers, each consisting of multiple neurons.

Each neuron in the neural network 826 operationally computes a function, such as an activation function, which takes as input the weighted sum of the outputs of the neurons in the previous layer, as well as a bias term. The output of this function is then passed as input to the neurons in the next layer. If the output of the activation function exceeds a certain threshold, an output is communicated from that neuron (e.g., transmitting neuron) to a connected neuron (e.g., receiving neuron) in successive layers. The connections between neurons have associated weights, which define the influence of the input from a transmitting neuron to a receiving neuron. During the training phase, these weights are adjusted by the learning algorithm to optimize the performance of the network. Different types of neural networks may use different activation functions and learning algorithms, affecting their performance on different tasks. The layered organization of neurons and the use of activation functions and weights enable neural networks to model complex relationships between inputs and outputs, and to generalize to new inputs that were not seen during training.

In some examples, the neural network 826 may also be one of several different types of neural networks, such as a single-layer feed-forward network, a Multilayer Perceptron (MLP), an Artificial Neural Network (ANN), a Recurrent Neural Network (RNN), a Long Short-Term Memory Network (LSTM), a Bidirectional Neural Network, a symmetrically connected neural network, a Deep Belief Network (DBN), a Convolutional Neural Network (CNN), a Generative Adversarial Network (GAN), an Autoencoder Neural Network (AE), a Restricted Boltzmann Machine (RBM), a Hopfield Network, a Self-Organizing Map (SOM), a Radial Basis Function Network (RBFN), a Spiking Neural Network (SNN), a Liquid State Machine (LSM), an Echo State Network (ESN), a Neural Turing Machine (NTM), or a Transformer Network, merely for example.

In addition to the training phase 804, a validation phase may be performed on a separate dataset known as the validation dataset. The validation dataset is used to tune the hyperparameters of a model, such as the learning rate and the regularization parameter. The hyperparameters are adjusted to improve the model's performance on the validation dataset. The validation dataset may also include one or more chat histories 280 as well as associated reviews and other transaction outcomes such as refunds or discounts being issued.

Once a model is fully trained and validated, in a testing phase, the model may be tested on a new dataset. The testing dataset is used to evaluate the model's performance and ensure that the model has not overfitted the training data.

In the prediction 710 phase, the trained ML program 802 uses the features 808 for analyzing query data 828 to generate inferences, outcomes, or predictions, as examples of a prediction/inference data 822. For example, during prediction 710 phase, the trained ML program 802 generates an output. Query data 828 is provided as an input to the trained ML program 802, and the trained ML program 802 generates the prediction/inference data 822 as output, responsive to receipt of the query data 828.

In some examples, the trained ML program 802 may be a generative AI model such as an LLM. Generative AI is a term that may refer to any type of artificial intelligence that can create new content from training data 806. For example, generative AI can produce text, images, video, audio, code, or synthetic data similar to the original data but not identical.

Some of the techniques that may be used in generative AI are: Convolutional Neural Networks, Recurrent Neural Networks, generative adversarial networks, variational autoencoders, transformer models, and the like. For example, Convolutional Neural Networks (CNNs) can be used for image recognition and computer vision tasks. CNNs may, for example, be designed to extract features from images by using filters or kernels that scan the input image and highlight important patterns. Recurrent Neural Networks (RNNs) can be used for processing sequential data, such as speech, text, and time series data, for example. RNNs employ feedback loops that allow them to capture temporal dependencies and remember past inputs. Generative adversarial networks (GANs) can include two neural networks: a generator and a discriminator. The generator network attempts to create realistic content that can “fool” the discriminator network, while the discriminator network attempts to distinguish between real and fake content. The generator and discriminator networks compete with each other and improve over time. Variational autoencoders (VAEs) can encode input data into a latent space (e.g., a compressed representation) and then decode it back into output data. The latent space can be manipulated to generate new variations of the output data. VAEs may use self-attention mechanisms to process input data, allowing them to handle long text sequences and capture complex dependencies. Transformer models can use attention mechanisms to learn the relationships between different parts of input data (such as words or pixels) and generate output data based on these relationships. Transformer models can handle sequential data, such as text or speech, as well as non-sequential data, such as images or code. In generative AI examples, the output prediction/inference data 822 can include predictions, translations, summaries, media content, and the like, or some combination thereof.

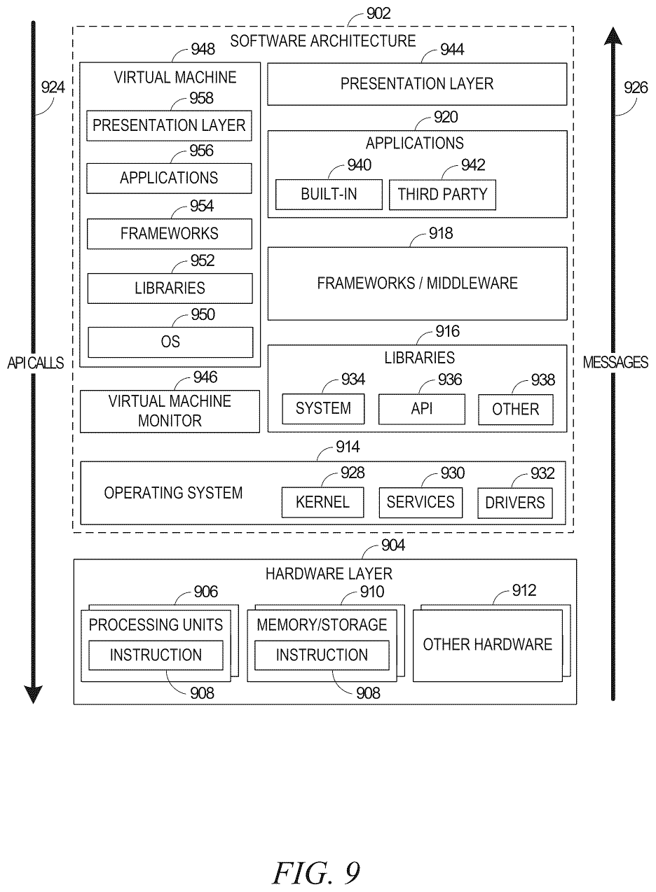

FIG. 9 is a block diagram illustrating an example of a software architecture 902 that may be installed on a machine, according to some examples. FIG. 9 is merely a non-limiting example of software architecture, and it will be appreciated that many other architectures may be implemented to facilitate the functionality described herein. The software architecture 902 may be executing on hardware such as a machine 1000 of FIG. 10 that includes, among other things, processors 1010, memory 1030, and input/output (I/O) components 1050. A representative hardware layer 904 is illustrated and can represent, for example, the machine 1000 of FIG. 10. The representative hardware layer 904 comprises one or more processing units 906 having associated executable instructions 908. The executable instructions 908 represent the executable instructions of the software architecture 902. The hardware layer 904 also includes memory or storage modules 910, which also have the executable instructions 908. The hardware layer 904 may also comprise other hardware 912, which represents any other hardware of the hardware layer 904, such as the other hardware illustrated as part of the machine 1000.

In the example architecture of FIG. 9, the software architecture 902 may be conceptualized as a stack of layers, where each layer provides particular functionality. For example, the software architecture 902 may include layers such as an operating system 914, libraries 916, frameworks/middleware 918, applications 920, and a presentation layer 944. Operationally, the applications 920 or other components within the layers may invoke API calls 924 through the software stack and receive a response, returned values, and so forth (illustrated as messages 926) in response to the API calls 924. The layers illustrated are representative in nature, and not all software architectures have all layers. For example, some mobile or special-purpose operating systems may not provide a frameworks/middleware 918 layer, while others may provide such a layer. Other software architectures may include additional or different layers.

The operating system 914 may manage hardware resources and provide common services. The operating system 914 may include, for example, a kernel 928, services 930, and drivers 932. The kernel 928 may act as an abstraction layer between the hardware and the other software layers. For example, the kernel 928 may be responsible for memory management, processor management (e.g., scheduling), component management, networking, security settings, and so on. The services 930 may provide other common services for the other software layers. The drivers 932 may be responsible for controlling or interfacing with the underlying hardware. For instance, the drivers 932 may include display drivers, camera drivers, Bluetooth® drivers, flash memory drivers, serial communication drivers (e.g., Universal Serial Bus (USB) drivers), Wi-Fi® drivers, audio drivers, power management drivers, and so forth depending on the hardware configuration.

The libraries 916 may provide a common infrastructure that may be utilized by the applications 920 and/or other components and/or layers. The libraries 916 typically provide functionality that allows other software modules to perform tasks in an easier fashion than by interfacing directly with the underlying operating system 914 functionality (e.g., kernel 928, services 930, or drivers 932). The libraries 916 may include system libraries 934 (e.g., C standard library) that may provide functions such as memory allocation functions, string manipulation functions, mathematic functions, and the like. In addition, the libraries 916 may include API libraries 936 such as media libraries (e.g., libraries to support presentation and manipulation of various media formats such as MPEG4, H.264, MP3, AAC, AMR, JPG, and PNG), graphics libraries (e.g., an OpenGL framework that may be used to render 2D and 3D graphic content on a display), database libraries (e.g., SQLite that may provide various relational database functions), web libraries (e.g., WebKit that may provide web browsing functionality), and the like. The libraries 916 may also include a wide variety of other libraries 938 to provide many other APIs to the applications 920 and other software components/modules.

The frameworks 918 (also sometimes referred to as middleware) may provide a higher-level common infrastructure that may be utilized by the applications 920 or other software components/modules. For example, the frameworks 918 may provide various graphical user interface functions, high-level resource management, high-level location services, and so forth. The frameworks 918 may provide a broad spectrum of other APIs that may be utilized by the applications 920 and/or other software components/modules, some of which may be specific to a particular operating system or platform.

The applications 920 include built-in applications 940 and/or third-party applications 942. Examples of representative built-in applications 940 may include, but are not limited to, a home application, a contacts application, a browser application, a book reader application, a location application, a media application, a messaging application, or a game application.

The third-party applications 942 may include any of the built-in applications 940, as well as a broad assortment of other applications. In a specific example, the third-party applications 942 (e.g., an application developed using the Android™ or iOS™ software development kit (SDK) by an entity other than the vendor of the particular platform) may be mobile software running on a mobile operating system such as iOS™, Android™, or other mobile operating systems. In this example, the third-party applications 942 may invoke the API calls 924 provided by the mobile operating system such as the operating system 914 to facilitate functionality described herein.

The applications 920 may utilize built-in operating system functions (e.g., kernel 928, services 930, or drivers 932), libraries (e.g., system libraries 934, API libraries 936, and other libraries 938), or frameworks/middleware 918 to create user interfaces to interact with users of the system. Alternatively, or additionally, in some systems, interactions with a user may occur through a presentation layer, such as the presentation layer 944. In these systems, the application/module “logic” can be separated from the aspects of the application/module that interact with the user.

Some software architectures utilize virtual machines. In the example of FIG. 9, this is illustrated by a virtual machine 948. The virtual machine 948 creates a software environment where applications/modules can execute as if they were executing on a hardware machine (e.g., the machine 1000 of FIG. 10). The virtual machine 948 is hosted by a host operating system (e.g., the operating system 914) and typically, although not always, has a virtual machine monitor 946, which manages the operation of the virtual machine 948 as well as the interface with the host operating system (e.g., the operating system 914). A software architecture executes within the virtual machine 948, such as an operating system 950, libraries 952, frameworks 954, applications 956, or a presentation layer 958. These layers of software architecture executing within the virtual machine 948 can be the same as corresponding layers previously described or may be different.

FIG. 10 illustrates a diagrammatic representation of a machine 1000 in the form of a computer system within which a set of instructions may be executed for causing the machine 1000 to perform any one or more of the methodologies discussed herein, according to some examples. Specifically, FIG. 10 shows a diagrammatic representation of the machine 1000 in the example form of a computer system, within which instructions 1016 (e.g., software, a program, an application, an applet, an app, or other executable code) for causing the machine 1000 to perform any one or more of the methodologies discussed herein may be executed. For example, the instructions 1016 may cause the machine 1000 to execute the process 300 or the method 400 described above. The instructions 1016 transform the general, non-programmed machine 1000 into a particular machine 1000 programmed to carry out the described and illustrated functions in the manner described. In alternative examples, the machine 1000 operates as a standalone device or may be coupled (e.g., networked) to other machines. In a networked deployment, the machine 1000 may operate in the capacity of a server machine or a client machine in a server-client network environment, or as a peer machine in a peer-to-peer (or distributed) network environment. The machine 1000 may comprise, but not be limited to, a server computer, a client computer, a personal computer (PC), a tablet computer, a laptop computer, a netbook, a personal digital assistant (PDA), an entertainment media system, a cellular telephone, a smart phone, a mobile device, or any machine capable of executing the instructions 1016, sequentially or otherwise, that specify actions to be taken by the machine 1000. Further, while only a single machine 1000 is illustrated, the term “machine” shall also be taken to include a collection of machines 1000 that individually or jointly execute the instructions 1016 to perform any one or more of the methodologies discussed herein.

The machine 1000 may include processors 1010, memory 1030, and I/O components 1050, which may be configured to communicate with each other such as via a bus 1002. In an example, the processors 1010 (e.g., a hardware processor, such as a central processing unit (CPU), a reduced instruction set computing (RISC) processor, a complex instruction set computing (CISC) processor, a graphics processing unit (GPU), a digital signal processor (DSP), an application-specific integrated circuit (ASIC), a radio-frequency integrated circuit (RFIC), another processor, or any suitable combination thereof) may include, for example, a processor 1012 and a processor 1014 that may execute the instructions 1016. The term “processor” is intended to include multi-core processors that may comprise two or more independent processors (sometimes referred to as “cores”) that may execute instructions contemporaneously. Although FIG. 10 shows multiple processors 1010, the machine 1000 may include a single processor with a single core, a single processor with multiple cores (e.g., a multi-core processor), multiple processors with a single core, multiple processors with multiples cores, or any combination thereof.

The memory 1030 may include a main memory 1032, a static memory 1034, and a storage unit 1036 including machine-readable medium 1038, each accessible to the processors 1010 such as via the bus 1002. The main memory 1032, the static memory 1034, and the storage unit 1036 store the instructions 1016 embodying any one or more of the methodologies or functions described herein. The instructions 1016 may also reside, completely or partially, within the main memory 1032, within the static memory 1034, within the storage unit 1036, within at least one of the processors 1010 (e.g., within the processor's cache memory), or any suitable combination thereof, during execution thereof by the machine 1000.

The I/O components 1050 may include a wide variety of components to receive input, provide output, produce output, transmit information, exchange information, capture measurements, and so on. The specific I/O components 1050 that are included in a particular machine will depend on the type of machine. For example, portable machines such as mobile phones will likely include a touch input device or other such input mechanisms, while a headless server machine will likely not include such a touch input device. It will be appreciated that the I/O components 1050 may include many other components that are not shown in FIG. 10. The I/O components 1050 are grouped according to functionality merely for simplifying the following discussion, and the grouping is in no way limiting. In some examples, the I/O components 1050 may include output components 1052 and input components 1054. The output components 1052 may include visual components (e.g., a display such as a plasma display panel (PDP), a light-emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input components 1054 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and/or force of touches or touch gestures, or other tactile input components), audio input components (e.g., a microphone), and the like.

In further examples, the I/O components 1050 may include biometric components 1056, motion components 1058, environmental components 1060, or position components 1062, among a wide array of other components. The motion components 1058 may include acceleration sensor components (e.g., accelerometer), gravitation sensor components, rotation sensor components (e.g., gyroscope), and so forth. The environmental components 1060 may include, for example, illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detect concentrations of hazardous gases for safety or to measure pollutants in the atmosphere), or other components that may provide indications, measurements, or signals corresponding to a surrounding physical environment. The position components 1062 may include location sensor components (e.g., a Global Positioning System (GPS) receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 1050 may include communication components 1064 operable to couple the machine 1000 to a network 1080 or devices 1070 via a coupling 1082 and a coupling 1072, respectively. For example, the communication components 1064 may include a network interface component or another suitable device to interface with the network 1080. In further examples, the communication components 1064 may include wired communication components, wireless communication components, cellular communication components, near field communication (NFC) components, Bluetooth® components (e.g., Bluetooth® Low Energy), Wi-Fi® components, and other communication components to provide communication via other modalities. The devices 1070 may be another machine or any of a wide variety of peripheral devices (e.g., a peripheral device coupled via a USB).

Moreover, the communication components 1064 may detect identifiers or include components operable to detect identifiers. For example, the communication components 1064 may include radio frequency identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, Ultra Code, UCC RSS-2D bar code, and other optical codes), or acoustic detection components (e.g., microphones to identify tagged audio signals). In addition, a variety of information may be derived via the communication components 1064, such as location via Internet Protocol (IP) geolocation, location via Wi-Fi® signal triangulation, location via detecting an NFC beacon signal that may indicate a particular location, and so forth.

Certain examples are described herein as including logic or a number of components, modules, elements, or mechanisms. Such modules can constitute either software modules (e.g., code embodied on a machine-readable medium or in a transmission signal) or hardware modules. A “hardware module” is a tangible unit capable of performing certain operations and can be configured or arranged in a certain physical manner. In various example embodiments, one or more computer systems (e.g., a standalone computer system, a client computer system, or a server computer system) or one or more hardware modules of a computer system (e.g., a processor or a group of processors) are configured by software (e.g., an application or application portion) as a hardware module that operates to perform certain operations as described herein.

In some examples, a hardware module is implemented mechanically, electronically, or any suitable combination thereof. For example, a hardware module can include dedicated circuitry or logic that is permanently configured to perform certain operations. For example, a hardware module can be a special-purpose processor, such as a field-programmable gate array (FPGA) or an ASIC. A hardware module may also include programmable logic or circuitry that is temporarily configured by software to perform certain operations. For example, a hardware module can include software encompassed within a general-purpose processor or other programmable processor. It will be appreciated that the decision to implement a hardware module mechanically, in dedicated and permanently configured circuitry, or in temporarily configured circuitry (e.g., configured by software) can be driven by cost and time considerations.

Accordingly, the phrase “module” should be understood to encompass a tangible entity, be that an entity that is physically constructed, permanently configured (e.g., hardwired), or temporarily configured (e.g., programmed) to operate in a certain manner or to perform certain operations described herein. Considering examples in which hardware modules are temporarily configured (e.g., programmed), each of the hardware modules need not be configured or instantiated at any one instance in time. For example, where a hardware module comprises a general-purpose processor configured by software to become a special-purpose processor, the general-purpose processor may be configured as respectively different special-purpose processors (e.g., comprising different hardware modules) at different times. Software can accordingly configure a particular processor or processors, for example, to constitute a particular hardware module at one instance of time and to constitute a different hardware module at a different instance of time.

Hardware modules can provide information to, and receive information from, other hardware modules. Accordingly, the described hardware modules can be regarded as being communicatively coupled. Where multiple hardware modules exist contemporaneously, communications can be achieved through signal transmission (e.g., over appropriate circuits and buses) between or among two or more of the hardware modules. In examples in which multiple hardware modules are configured or instantiated at different times, communications between or among such hardware modules may be achieved, for example, through the storage and retrieval of information in memory structures to which the multiple hardware modules have access. For example, one hardware module performs an operation and stores the output of that operation in a memory device to which it is communicatively coupled. A further hardware module can then, at a later time, access the memory device to retrieve and process the stored output. Hardware modules can also initiate communications with input or output devices, and can operate on a resource (e.g., a collection of information).

The various operations of example methods described herein can be performed, at least partially, by one or more processors that are temporarily configured (e.g., by software) or permanently configured to perform the relevant operations. Whether temporarily or permanently configured, such processors constitute processor-implemented modules that operate to perform one or more operations or functions described herein. As used herein, “processor-implemented module” refers to a hardware module implemented using one or more processors.

Similarly, the methods described herein can be at least partially processor-implemented, with a particular processor or processors being an example of hardware. For example, at least some of the operations of a method can be performed by one or more processors or processor-implemented modules. Moreover, the one or more processors may also operate to support performance of the relevant operations in a “cloud computing” environment or as a “software as a service” (SaaS). For example, at least some of the operations may be performed by a group of computers (as examples of machines 1000 including processors 1010), with these operations being accessible via a network (e.g., the Internet) and via one or more appropriate interfaces (e.g., an API). In certain embodiments, for example, a client device may relay or operate in communication with cloud computing systems and may access circuit design information in a cloud environment.

The performance of certain of the operations may be distributed among the processors, not only residing within a single machine 1000, but deployed across a number of machines 1000. In some examples, the processors 1010 or processor-implemented modules are located in a single geographic location (e.g., within a home environment, an office environment, or a server farm). In other example embodiments, the processors or processor-implemented modules are distributed across a number of geographic locations.

The various memories (i.e., 1030, 1032, 1034, and/or the memory of the processor(s) 1010) and/or the storage unit 1036 may store one or more sets of instructions 1016 and data structures (e.g., software) embodying or utilized by any one or more of the methodologies or functions described herein. These instructions (e.g., the instructions 1016), when executed by the processor(s) 1010, cause various operations to implement the disclosed embodiments.

As used herein, the terms “machine-storage medium,” “device-storage medium,” and “computer-storage medium” mean the same thing and may be used interchangeably. The terms refer to a single or multiple storage devices and/or media (e.g., a centralized or distributed database, and/or associated caches and servers) that store executable instructions 1016 and/or data. The terms shall accordingly be taken to include, but not be limited to, solid-state memories, and optical and magnetic media, including memory internal or external to processors. Specific examples of machine-storage media, computer-storage media and/or device-storage media include non-volatile memory, including by way of example semiconductor memory devices, e.g., erasable programmable read-only memory (EPROM), electrically erasable programmable read-only memory (EEPROM), FPGA, and flash memory devices; magnetic disks such as internal hard disks and removable disks; magneto-optical disks; and CD-ROM and DVD-ROM disks. The terms “machine-storage medium,” “computer-storage medium,” and “device-storage medium” specifically exclude carrier waves, modulated data signals, and other such media, at least some of which are covered under the term “signal medium” discussed below.

In some examples, one or more portions of the network 1080 may be an ad hoc network, an intranet, an extranet, a virtual private network (VPN), a LAN, a wireless LAN (WLAN), a WAN, a wireless WAN (WWAN), a metropolitan-area network (MAN), the Internet, a portion of the Internet, a portion of the public switched telephone network (PSTN), a plain old telephone service (POTS) network, a cellular telephone network, a wireless network, a Wi-Fi® network, another type of network, or a combination of two or more such networks. For example, the network 1080 or a portion of the network 1080 may include a wireless or cellular network, and the coupling 1082 may be a Code Division Multiple Access (CDMA) connection, a Global System for Mobile communications (GSM) connection, or another type of cellular or wireless coupling. In this example, the coupling 1082 may implement any of a variety of types of data transfer technology, such as Single Carrier Radio Transmission Technology (1xRTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High-Speed Packet Access (HSPA), Worldwide Interoperability for Microwave Access (WiMAX), Long-Term Evolution (LTE) standard, others defined by various standard-setting organizations, other long-range protocols, or other data transfer technology.

The instructions may be transmitted or received over the network using a transmission medium via a network interface device (e.g., a network interface component included in the communication components) and utilizing any one of a number of well-known transfer protocols (e.g., hypertext transfer protocol (HTTP)). Similarly, the instructions may be transmitted or received using a transmission medium via the coupling (e.g., a peer-to-peer coupling) to the devices 1070. The terms “transmission medium” and “signal medium” mean the same thing and may be used interchangeably in this disclosure. The terms “transmission medium” and “signal medium” shall be taken to include any intangible medium that is capable of storing, encoding, or carrying the instructions for execution by the machine, and include digital or analog communications signals or other intangible media to facilitate communication of such software. Hence, the terms “transmission medium” and “signal medium” shall be taken to include any form of modulated data signal, carrier wave, and so forth. The term “modulated data signal” means a signal that has one or more of its characteristics set or changed in such a manner as to encode information in the signal.

The terms “machine-readable medium,” “computer-readable medium,” and “device-readable medium” mean the same thing and may be used interchangeably in this disclosure. The terms are defined to include both machine-storage media and transmission media. Thus, the terms include both storage devices/media and carrier waves/modulated data signals. For instance, an embodiment described herein can be implemented using a non-transitory medium (e.g., a non-transitory computer-readable medium).

Throughout this specification, plural instances may implement resources, components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components.

As used herein, the term “or” may be construed in either an inclusive or exclusive sense. The terms “a” or “an” should be read as meaning “at least one,” “one or more,” or the like. The presence of broadening words and phrases such as “one or more,” “at least,” “but not limited to,” or other like phrases in some instances shall not be read to mean that the narrower case is intended or required in instances where such broadening phrases may be absent. Additionally, boundaries between various resources, operations, modules, engines, and data stores are somewhat arbitrary, and particular operations are illustrated in a context of specific illustrative configurations. Other allocations of functionality are envisioned and may fall within a scope of various embodiments of the present disclosure. The specification and drawings are, accordingly, to be regarded in an illustrative rather than a restrictive sense.

It will be understood that changes and modifications may be made to the disclosed embodiments without departing from the scope of the present disclosure. These and other changes or modifications are intended to be included within the scope of the present disclosure.

What is claimed is:

1. A system comprising:
one or more processors; and
a memory storing instructions that, when executed by the one or more processors, cause the one or more processors to perform operations comprising:
receiving, by at least one hardware processor, a message from a first device of a first user for sending to a second device of a second user;
generating context for the message based on a chat history between the first user and the second user, the chat history comprising one or more messages exchanged between the first user and the second user prior to receiving the message;
classifying, by a machine learning model trained to classify an intention of messages, the message as attempted extortion based on content of the message and the context for the message; and
based on classifying the message as attempted extortion, preventing, by the at least one hardware processor, the message from being sent to the second device of the second user.

2. The system of claim 1, wherein the operations comprise:
providing the message for processing by a verification agent in response to classifying the message as attempted extortion; and
verifying, by the verification agent, whether the message is properly classified as attempted extortion.

3. The system of claim 2, wherein the operations comprise:
receiving, from the verification agent, input permitting the message to be sent to the second device of the second user; and
based on the input, sending the message to the second device of the second user.

4. The system of claim 2, wherein the verifying whether the message is properly classified as attempted extortion comprises:
communicating, by the verification agent, with the first user regarding the message; and
communicating, by the verification agent, with the second user regarding the message.

5. The system of claim 2, comprising:
receiving, from the verification agent, input indicating that the message is improperly classified as attempted extortion; and
retraining the machine learning model using the input.

6. The system of claim 1, wherein the generating of the context is further based on at least one of: a user profile of the first user, a user profile of the second user, a transaction history of the first user, a transaction history of the second user, a feedback history of the first user, and a feedback history of the second user.

7. The system of claim 1, wherein the operations comprise causing display, at the second device of the second user, of a notification of the message being prevented from being sent to the second device.

8. A method comprising:
receiving, by at least one hardware processor, a message from a first device of a first user for sending to a second device of a second user;
generating context for the message based on a chat history between the first user and the second user, the chat history comprising one or more messages exchanged between the first user and the second user prior to receiving the message;
classifying, by a machine learning model trained to classify an intention of messages, the message as attempted extortion based on content of the message and the context for the message; and
based on classifying the message as an attempted extortion, preventing, by at least one hardware processor, the message from being sent to the second device of the second user.

9. The method of claim 8, comprising:
providing the message for processing by a verification agent in response to classifying the message as attempted extortion; and
verifying, by the verification agent, whether the message is properly classified as attempted extortion.

10. The method of claim 9, comprising:
receiving, from the verification agent, input permitting the message to be sent to the second device of the second user; and
based on the input, sending the message to the second device of the second user.

11. The method of claim 9, wherein the verifying whether the message is properly classified as attempted extortion comprises:
communicating, by the verification agent, with the first user regarding the message; and
communicating, by the verification agent, with the second user regarding the message.

12. The method of claim 9, comprising:
receiving, from the verification agent, input indicating that the message is improperly classified as attempted extortion; and
retraining the machine learning model using the input.

13. The method of claim 8, wherein the generating of the context is further based on at least one of: a user profile of the first user, a user profile of the second user, a transaction history of the first user, a transaction history of the second user, a feedback history of the first user, and a feedback history of the second user.

14. The method of claim 8, comprising causing display, at the second device of the second user, of a notification of the message being prevented from being sent to the second device.

15. The method of claim 14, comprising causing display, by the second device, of an interactive interface comprising a conversation view, the conversation view comprising a chat history between the first and second user, wherein the notification is displayed within the conversation view.

16. The method of claim 8, wherein the message comprises at least one of: text, audio, an image, or a video.

17. The method of claim 8, comprising training the machine learning model using training data, the training data comprising a set of messages exchanged between users on a network-based platform, transaction outcomes associated with transactions on the network-based platform, and user feedback published by the network-based platform.

18. The method of claim 8, wherein:
the message is a first message;
the method comprises:
receiving a second message from the first device of the first user for sending to the second device of the second user;
determining, by the machine learning model, a classification of the second message;
determining, based on the classification, that the second message is not classified as attempted extortion; and
based on determining the second message is not classified as attempted extortion, sending the second message to the second device of the second user.

19. The method of claim 8, wherein the machine learning model comprises a large language learning model.

20. A machine-storage medium comprising instructions which, when executed by one or more processors of a machine, cause the machine to perform operations comprising:
receiving, by at least one hardware processor, a message from a first device of a first user for sending to a second device of a second user;
generating context for the message based on a chat history between the first user and the second user, the chat history comprising one or more messages exchanged between the first user and the second user prior to receiving the message;
classifying, by a machine learning model trained to classify an intention of messages, the message as attempted extortion based on content of the message and the context for the message; an
based on classifying the message as attempted extortion, preventing, by the at least one hardware processor, the message from being sent to the second device of the second user.
